(19) United States
(12) Patent Application Publication
(10) Pub. No.: US 2008/0286021 A1
(43) Pub. Date: Nov. 20, 2008

(54) Image recording apparatus

(75) Inventor: Keiichi Asami, Hachioji-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 12/152,214

(22) Filed: May 13, 2008

(30) Foreign Application Priority Data
May 15, 2007 (JP) 2007-129679

(51) Int. Cl. G03G 21/00

(52) U.S. Cl. 399/351

(57) ABSTRACT

An image recording apparatus according to the invention has a nozzle plate having a nozzle hole for ejecting ink, a wiper blade for cleaning the nozzle plate, a blade holder holding the wiper blade, and a wiper base containing and holding the blade holder. When the wiper blade abuts on the nozzle plate, the blade holder is held and inclined in the wiper base so that the wiper blade follows the nozzle plate.

### CROSS-REFERENCE TO RELATED APPLICATIONS

This application is based upon and claims the benefit of priority from prior Japanese Patent Application No. 2007-129679, filed May 15, 2007, the entire contents of which are incorporated herein by reference.

### BACKGROUND OF THE INVENTION

1. Field of the Invention

The present invention relates to an image recording apparatus, and in particular to an improved image recording apparatus that can eject ink over a long use.

2. Description of the Related Art

Ink-jet recording apparatuses are designed to perform desired recording by ejecting a very small quantity of ink through very small nozzles provided in an ink-jet head, and ejecting the ink to a recording medium. Various types of ink-jet heads for use in ink-jet recording apparatuses are known. Among these types are a piezoelectric system having piezoelectric elements and a thermal system having heaters. In an ink-jet head of either system, foreign matters such as dust or paper dust and ink of increased viscosity adhere to the nozzle plate having nozzle holes. The foreign matters and the ink lower the printing quality.

To solve this problem, the conventional ink-jet recording apparatus comprises a cleaning mechanism that has a wiper blade formed of an elastic member and designed to wipe the nozzle plate. The wiper blade removes the foreign matters from the nozzle plate.

However, the positional relation between the nozzle plate and the wiper blade is not always as desired or designed, because the components of the ink-jet head and cleaning mechanism are not so precise in dimensions and not accurately positioned in assembling the ink-jet head. In this regard, a wiper unit is known, which comprises a wiping member for wiping the surface of a nozzle plate, a guide unit for guiding linearly the wiping member along a guiding direction, and an energizing unit for energizing the wiping member to the nozzle surface, as is disclosed in Jpn. Pat. Appln. KOKAI Publication No. 2005-40975. This publication also discloses a method of pressing the wiping member to the nozzle plate, even if a clearance between the wiping member and nozzle plate surface changes.

### BRIEF SUMMARY OF THE INVENTION

An image recording apparatus according to the present invention comprises:

a nozzle plate having a nozzle hole to eject ink;

a wiper blade for cleaning the nozzle plate;

a blade holder for holding the wiper blade; and

a wiper base which contains the blade holder, and holds the blade holder,

wherein when the wiper blade abuts on the nozzle plate, the blade holder is held in the wiper base to be inclinable in a direction substantially perpendicular to a direction in which the wiper blade cleans the nozzle plate.

An image recording apparatus comprising:

a nozzle plate having a nozzle hole to eject ink;

a wiper blade having a through hole for cleaning the nozzle plate;

a support shaft inserted in the through and supporting the wiper blade; and

a wiper base to hold the support shaft,

wherein when the wiper blade abuts on the nozzle plate, the wiper blade is rotated about the support shaft with respect to the wiper base, following the nozzle plate surface and rotating in a direction substantially at right angles to the direction in which the cleaning of the nozzle plate proceeds.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a side view showing the configuration of an image recording apparatus according to a first embodiment of the invention;

FIG. 2 is a top view of a head unit 14 of an image recording apparatus 10 of FIG. 1;

FIG. 3 is a diagram showing the head unit 14 and a maintenance unit 18 viewed from the upstream side of a conveying direction (in the direction of arrow A in FIG. 2);

FIGS. 4A to 4G are side views for explaining the operations of the head unit 14 and maintenance unit 18;

FIGS. 5A and 5B are top views for explaining the operations of the head unit 14 and maintenance unit 18;

FIG. 6A is a perspective view of a maintenance block 50 comprising a wiper unit 40, a suction unit 42, and a holder 44;

FIG. 6B is a side view of the maintenance block (in the direction of arrow B in FIG. 6A);

FIGS. 7A to 7H are views showing the maintenance block 50 shown in FIGS. 6A and 6B, FIGS. 7A, 7C, 7E, 7G and 7H being front views (in the direction of arrow C in FIG. 6A), and FIGS. 7B, 7D and 7F being side views (in the direction of arrow B in FIG. 6A);

FIG. 8A is a diagram showing a blade end part 120 that has yet to touch a nozzle plate surface 122;

FIG. 8B is a diagram showing the blade end part that has touched the nozzle plate surface;

FIG. 8C is a diagram showing a wiper blade 72 that is wiping the nozzle plate surface 122;

FIGS. 9A to 9C shows views showing examples of the weight balance of a blade unit;

FIGS. 10A to 10E are diagrams showing the positions an ink-jet head 36 and a maintenance block 50 assume as viewed from the upstream of a conveying direction (as viewed in the direction of arrow A in FIG. 2);

FIGS. 11A to 11C are diagrams showing the positions the ink-jet head 36 and maintenance block 50 assume, as viewed from the direction of arrow D shown in FIG. 3;

FIG. 12 is a view showing another example of positioning the wiper unit in the Z-direction;

FIGS. 13A to 13C are diagrams explaining the cases wherein the weight balance of a blade unit deviates from the centerline in which the balance is substantially equal;

FIG. 14 is a diagram showing an example of the staggered arrangement of the wiper unit 40;

FIGS. 15A and 15B shows views showing an example of molding a blade unit only in one wiper blade;

FIGS. 16A to 16F are diagrams explaining how a modification of the wiper unit 40 according to the first embodiment of the invention is assemble, FIGS. 16A, 16C and 16E being front views (as seen in the direction of arrow C in FIG. 6A), and FIGS. 16B, 16D and 16F being side views (as seen in the direction of arrow B in FIG. 6A);

FIGS. 17A to 17F are diagrams explaining how another modification of the wiper unit 40 according to the first embodiment of the invention is assembled, FIGS. 17A, 17C and 17E being front views (as seen in the direction of arrow C in FIG. 6A), and FIGS. 17B, 17D and 17F being side views (as seen in the direction of arrow B shown in FIG. 6A);

FIGS. 18A to 18F are diagrams explaining how a third modification of the wiper unit 40 according to the first embodiment of the invention is assembled, FIGS. 18A, 18C and 18E being front views (as seen in the direction of arrow C in FIG. 6A), and FIGS. 18B, 18D and 18F being side views (as seen in the direction of arrow B shown in FIG. 6A);

FIGS. 19A to 19F are diagrams explaining how a blade unit, a wiper unit and a maintenance block of an image recording apparatus according to a second embodiment of the invention are assembled, FIGS. 19A, 19B and 19D being side views (in the direction of arrow B in FIG. 6A), and FIGS. 19C, 19E and 19F being front views (in the direction of arrow C shown in FIG. 6A);

FIG. 20A is a diagram explaining how a spring 204 holds a blade unit 80₆ with a force not hindering the rotation;

FIG. 20B is a diagram explaining a method of supporting a wiper unit 40₄ comprising a blade unit 80₆, a spring 204 and a wiper base 96₄;

FIG. 20C is a diagram showing the state a maintenance block 50₁ assumes while the wiper unit 40₄ remains secured to a holder 44₁;

FIG. 21 is a diagram showing an example in which a stopper 208 is formed on a wiper base 96₄, instead of the spring 204, in the wiper unit 40₄ of the image recording apparatus according to the second embodiment;

FIGS. 22A to 22D are diagrams showing how a modification of the wiper unit of the second embodiment is assembled, FIGS. 22A and 22C being front views (as seen in the direction of arrow C in FIG. 6A), and FIGS. 22B and 22D being side views (as seen in the direction of arrow B shown in FIG. 6A);

FIGS. 23A to 23H are diagrams showing a blade unit and a wiper unit of an image recording apparatus according to a third embodiment of the invention, FIGS. 23A, 23C, 23E and 23G being front views (as seen in the direction of arrow C in FIG. 6A), and FIGS. 23B, 23D, 23F and 23H being side views (in the direction of arrow B shown in FIG. 6A); and

FIG. 24 is a diagram showing an example of a leaf spring 220₁ of a blade unit used in the third embodiment, which has a small width.

### DETAILED DESCRIPTION OF THE INVENTION

Embodiments of the invention will be explained with reference to the accompanying drawings.

### Embodiment 1

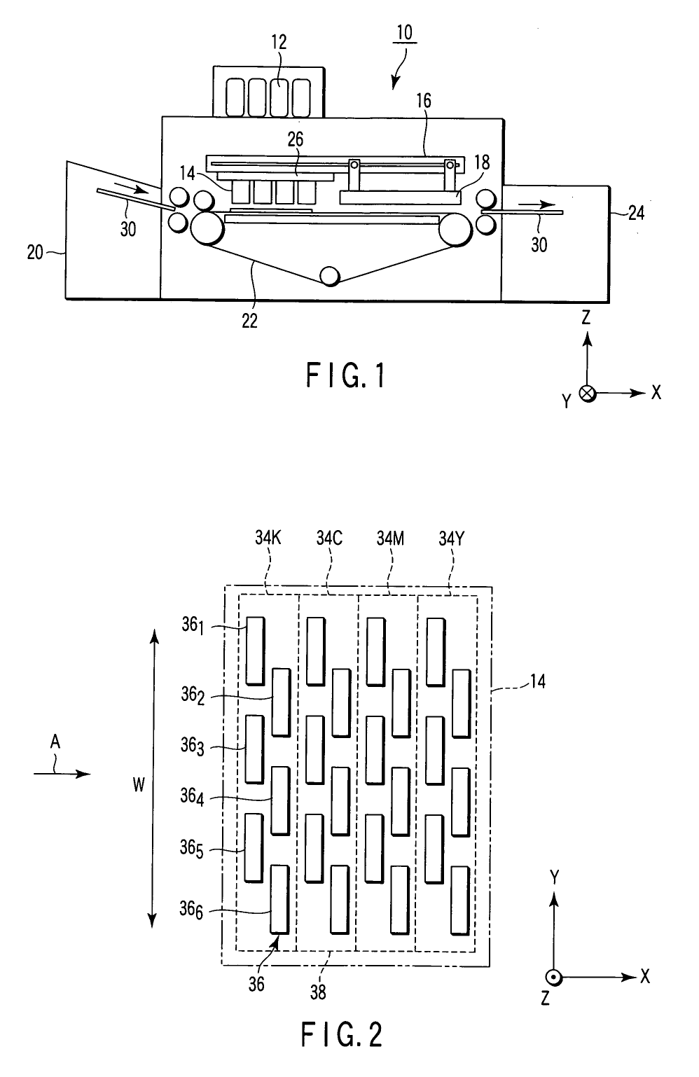

FIG. 1 is a side view showing the configuration of an image recording apparatus according to a first embodiment of the invention.

Arrows X, Y and Z shown in the drawings indicate a direction of conveying a recording medium, a width direction of a recording medium, and a direction of intersecting them, respectively.

As shown in FIG. 1, an image recording apparatus 10 of the invention comprises an inkbottle 12, a head unit 14, a base 16, a maintenance unit 18, a supplying unit 20, a conveying unit 22, a collecting unit 24, and a carriage 26.

The supplying unit 20 contains a plurality of recording medium 30. The supplying unit 20 supplies the recording medium 30 to the conveying unit 22. The conveying unit 22 conveys the recording medium 30 to a position in front of the head unit 14, by using a belt, in synchronization with the timing the head unit 14 ejects ink. The head unit 14 ejects ink through the nozzles made in the nozzle plate of each ink-jet head, thus recording an image on the recording medium 30 conveyed by the conveying unit 22. The collecting unit 24 collects the recording medium 30 on which the image has been recorded by the head unit 14 and which has been ejected from the conveying unit 22.

The base 16 is fixed to the housing (not shown) of the image recording apparatus 10. The base 16 supports the carriage 26 and maintenance unit 18. The carriage 26 supports the head unit 14 and has a mechanism than can change a clearance between the head unit 14 and the recording medium 30 conveyed by the conveying unit 22. The maintenance unit 18 has a mechanism to clean the nozzle plate of the head unit 14.

The image recording apparatus 10 further comprises an ink supply unit to supply ink of the inkbottle 12 to the head unit 14, and an electrical unit to control the image recording apparatus 10 and process an image.

FIG. 2 is a top view of the head unit 14 of the image recording apparatus 10. FIG. 2 is a perspective top view of the head unit 14, showing the arrangement of the base 16 and carriage 26 in FIG. 1.

As shown in FIG. 2, the head unit 14 has six ink-jet heads 36 (36₁-36₆), for example, arranged in a staggered configuration for each of four colors (black (34K), cyan (34C), magenta (34M) and yellow (34Y)). As six ink-jet heads are arranged in a zigzag, a nozzle of a nozzle plate of each ink-jet head 36 is arranged continuous to the width direction of a recording medium (Y-direction). With this arrangement, interruption-free printing is possible among the ink-jet heads 36. Therefore, a line head 38 can be configured to have a printing width W of approximately 300 mm (W=300 mm). In this embodiment, the head unit 14 is composed of parallel four sets of line head 38 for four colors.

Further, in this configuration, data is completely printed on one side of the recording medium 30, simply by conveying the recording medium once to a position where the recording medium is opposite to the head unit 14. If a not-shown recording medium reversing unit is provided, the recording medium 30 can be printed on both sides by being reversed by the unit and re-conveyed to the head unit 14.

In the ink-jet head 36, in order to keep ejecting ink, the nozzle plate surface is coated with a liquid-repellent layer with a high water-repellence for water-base ink and a high oil-repellence for oil-base ink. When the recording medium 30 is conveyed to the position opposite to the nozzle plate, the recording medium 30 may interfere with the surface of the nozzle plate due to warping of the end part of the recording medium or jamming caused by abnormal conveyance. In such a case, the liquid-repellent layer on the nozzle plate surface may be broken, or the nozzle plate itself is damaged. As a result, the ink ejection may be adversely influenced, ultimately degrading the recording quality.

Therefore, a mask plate is formed as a projection over the nozzle plate. A mask plate is made of metal or resin. In this embodiment, oil-base ink is used, a polyimide file is used for the nozzle plate, and the surface of the nozzle plate is coated with fluorine with high oil-repellence.

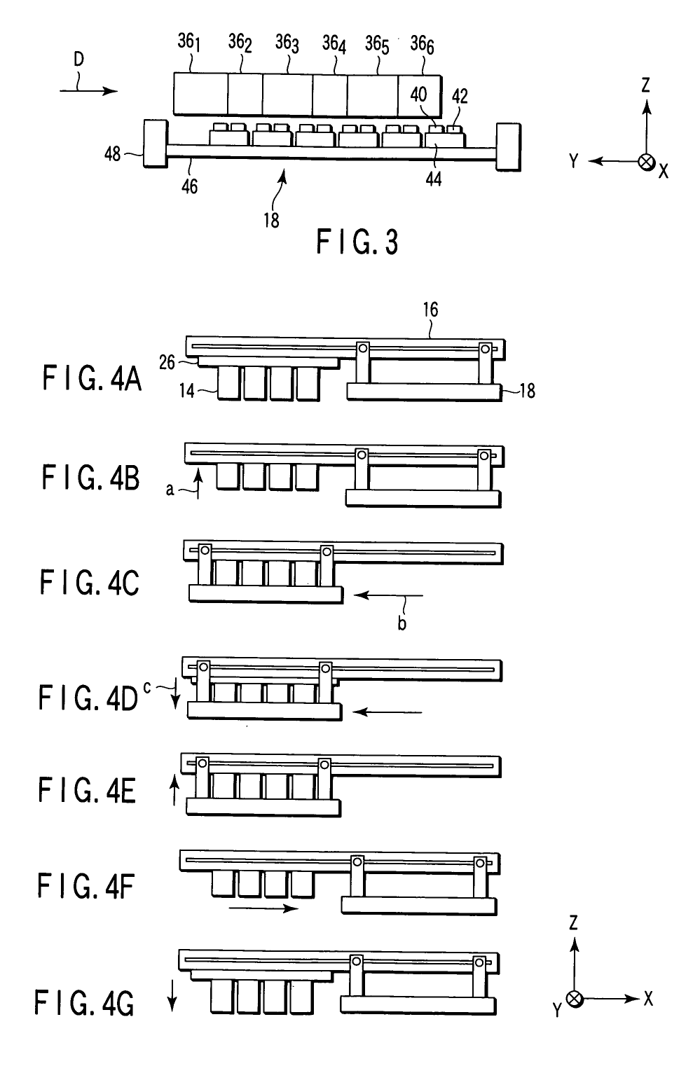

FIG. 3 is a diagram showing the head unit 14 and maintenance unit 18 viewed from the upstream of a conveying direction (in the direction of arrow A in FIG. 2). FIG. 3 shows the head unit 14 and maintenance unit 18, both located at the positions shown in FIG. 4C as will be described later.

The maintenance unit 18 has holders 44 as shown in FIG. 3. Each holder 44 makes a pair with one ink-jet head 36. A wiper unit 40 and a suction unit 42 are arranged on the holder 44. The holder 44 is supported by an ink-receiving unit 46. The ink-receiving unit 46 is supported by a support member 48, able to slide in the Y-direction. The support member 48 is supported on the base 16 of the image recording apparatus, able to slide in the X-direction.

When the nozzle plate of the ink-jet head 36 is cleaned, a pump applies a pressure in a ink tank (not shown). Therefore, ink is thereby supplied to the head unit 14 and forced out through the nozzle of the ink-jet head 36. Then, the wiper unit 40 wipes the nozzle plate wetted with the pressed-out ink. The suction unit 42 draws the ink from the nozzle plate. The ink thus drawn passes through a waste liquid path (not shown) and eventually collected in a waste liquid bottle.

Ink may flow down along the wiper unit 40 or suction unit 42. Such ink is gathered at the ink-receiving unit 46 and collected in the waste liquid bottle after flowing through a waste liquid path, in the same way as described above. In this embodiment, as describe above, ink is forced out through the nozzle of the ink-jet head 36 before wiping, and the nozzle plate surface is wetted with ink or ink drops are formed, by design, on the nozzle plate surface.

This not only forces out the foreign matters and bubbles from the nozzle of the ink-jet head 36. But also does it make the dust and paper dust come off the nozzle plate and wash the dust and paper dust away from the wiper blade immediately after the blade has wiped the nozzle plate.

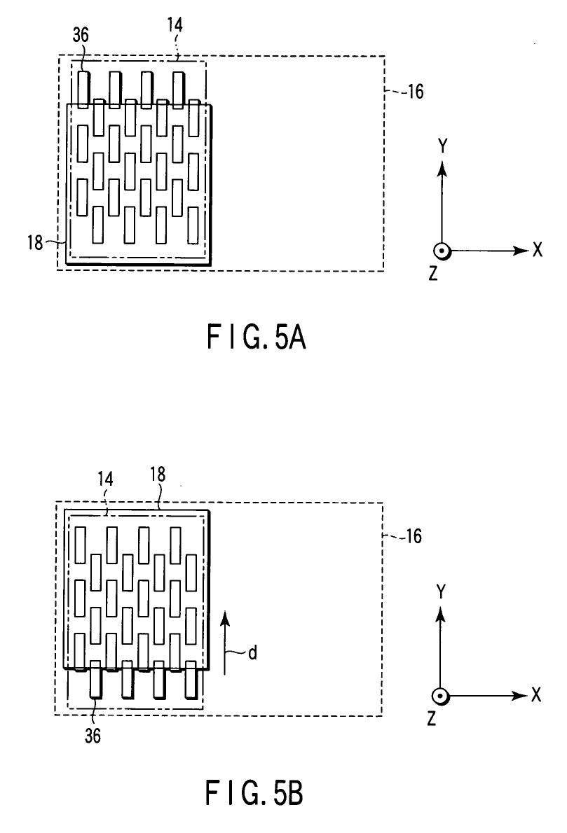

FIGS. 4A to 4G are side views of the head unit 14 and maintenance unit 18, and FIGS. 5A and 5B are top views thereof. FIGS. 5A and 5B are also perspective views of the head unit 14 and maintenance unit 18, showing the arrangement of the base 16 and carriage 26 in FIG. 1 as seen from above. FIGS. 4 to 4G and FIGS. 5A and 5B show the positional relation the head unit 14 and the maintenance unit 18 have during the maintenance operation.

FIG. 4A shows the home positions of the head unit 14 and maintenance unit 18. At the home position, the head unit 14 is spaced by such a distance from the belt surface of the conveying unit 22 that the unit 14 may record an image. In other words, the carriage 26 is supported on the base 16, so that any desired clearance may be provided between the head unit 14 and the belt surface of the conveying unit 22, so that the head unit may record an image. The maintenance unit 18 is supported on the base 16 at a position where it does not interfere with the conveyed recording medium 30.

FIG. 4B shows the state the apparatus assumes immediately after the maintenance operation is started. The carriage 26 is moved upward, in the direction of arrow a, to increase the clearance between the head unit 14 and the belt surface.

Next, the maintenance unit 18 slides in the direction of arrow b until it come to face the head unit 14. At this point, the maintenance unit 18 does not abut on the maintenance unit 18.

At the next point, the carriage 26 is moved down, as shown in FIG. 4D, to a predetermined position in the direction of arrow c. Therefore, the head unit 14 abuts on the maintenance unit 18.

FIG. 5A is a top view of the state shown in FIG. 4D.

The wipe unit 40 and suction unit 42 arranged in the maintenance unit 18 are placed at the end part of the ink-jet head 36.

Next, as shown in FIG. 5B, the maintenance unit 18 moves in the direction of arrow d. As the unit 18 moves so, the wiper unit 40 and suction unit 42 move on the nozzle plate of the ink-jet head 36, cleaning the nozzle plate. After the cleaning, the carriage 26 is moved up as shown in FIG. 4E. Next, as shown in FIG. 4F, the maintenance unit 18 slides back to the home position. Finally, as shown in FIG. 4G, the carriage 26 is moved down to the position, where an image can be formed.

As described above, the head unit 14 and maintenance unit 18 return to their respective home positions as they move in the directions opposite to those in which they move as shown in FIGS. 4B, 4C and 4D.

The carriage is moved up and down during the maintenance operation. The ink tank, which is set to a water head necessary for forming a meniscus, moves up and down, too. In view of this, the ink tank may be supported by the carriage to move in interlock with the carriage, in order not to break the meniscus formed in the nozzle of the ink-jet head 36.

The carriage is vibrated when it moves. The vibration also imposes an adverse influence on the meniscus. In this embodiment, a vibration-absorbing member is interposed between the carriage 26 and the base 16, imposing on influence on the meniscus. Further, as long as the maintenance unit 18 remains at the home position, the wiper unit 40 may be cleaned by applying cleaning liquid or ink, or by wiping off with a cleaning sheet.

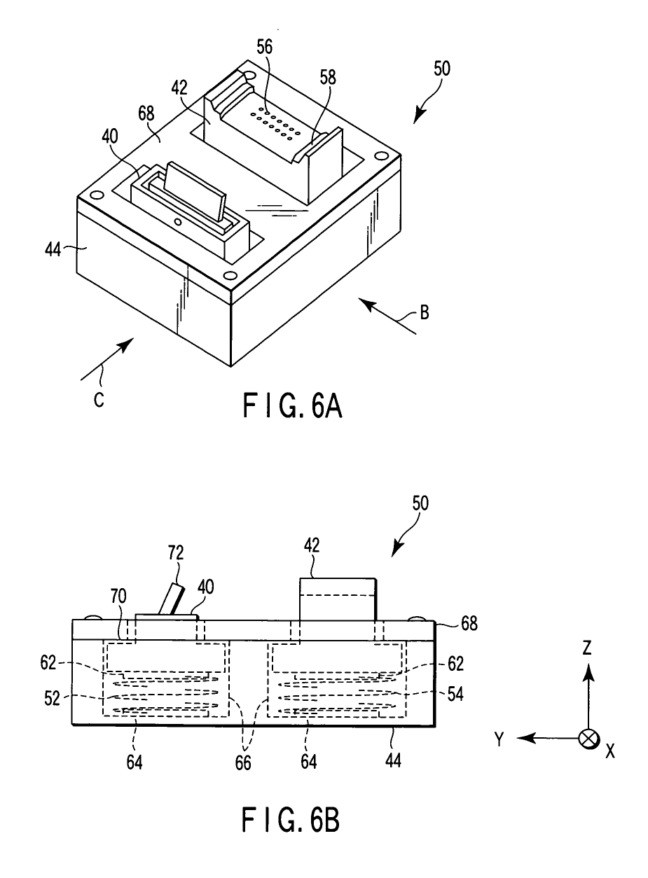

FIG. 6A is a perspective view of a maintenance block 50 that comprises the wiper unit 40, suction unit 42 and holder 44 shown in FIG. 3. FIG. 6B is a side view of the maintenance block (as viewed in the direction of arrow B shown in FIG. 6A).

The wiper unit 40 is supported by the holder 44 through a spring 52 and biased toward the surface of the nozzle plate of the ink-jet head 36. Therefore, during the maintenance operation, the wiper unit 40 remains pressed to the nozzle plate of the ink-jet head 36 at any given pressure. The suction unit 42 is supported by the holder 44 through a spring 54 and biased toward the surface of the mask plate that surrounds the nozzle plate of the ink-jet head 36.

A guide 58 is formed in the suction unit 42, preventing the surface of the suction unit 42 having the suction hole 56 from grazing the nozzle plate surface during the maintenance operation. Since the guide 58 touches the mask plate formed around the nozzle plate, a predetermined clearance develops between the nozzle plate and the suction hole 56. Therefore, the nozzle plate surface is not damaged.

The wiper unit 40 and suction unit 42 have a projection 62 each, which positions the spring. The holder 44 has a projection 64; too, which faces the projections 62.

The projections 62 and 64 are shaped not to touch each other even when the spring 52 is compressed by the maintenance operation. To limit the spring compression amount to a desired value, however, the position where the projections 62 and 64 touch each other can be changed. The maintenance block 50 is configured, so that a part of the inside wall 66 of the holder 44 may serve as a guide and the wiper unit 40 and suction unit 42 may move, sliding, in the Z-direction. The sliding range is limited to the compression limit position of the springs 52 and 54 to the position where a part of the wall surfaces of the wipe unit 40 and suction unit 42 butts against a backside 70 of a cover 68.

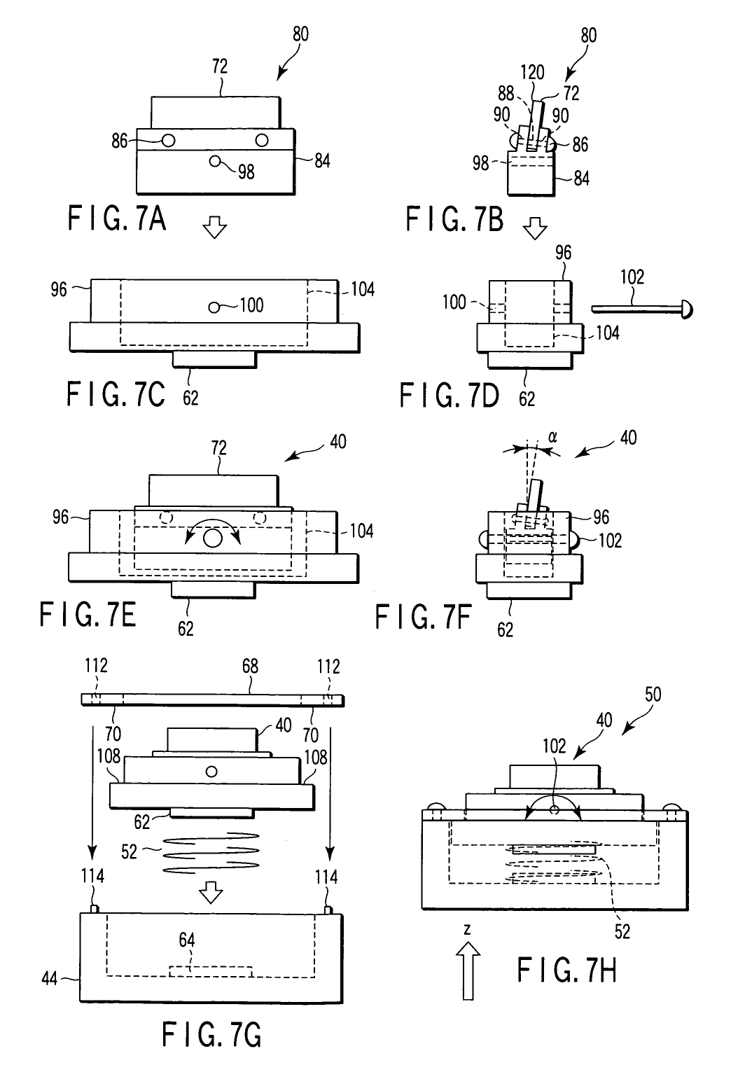

FIGS. 7A to 7H show in detailed how the maintenance block 50, particularly the wiper unit 40, shown in FIGS. 6A and 6B is assembled. FIGS. 7A, 7C, 7E, 7G and 7H, are front views (as seen in the direction of arrow C in FIG. 6A), and FIGS. 7B, 7D and 7F are side views as seen (in the direction of arrow B in FIG. 6A).

First, a method of supporting a wiper blade 72 will be explained, with reference to FIGS. 7A and 7B.

A blade unit 80 comprises a wiper blade 72, a blade holder 84, and a support member 86. The wiper blade 72 has a through hole 88, as shown in FIG. 7B. In the present embodiment, the wiper blade 72 has two through holes 88. The blade holder 84 has a through hole 90 that axially aligns with the through hole 88 of the wiper blade 72. The support member 86 is inserted in the through holes 88 and 90 made in the wiper blade 72 and the blade holder 84, respectively. The wiper blade 72 is thereby fixed to the blade holder 84.

The support member 86 is fitted or bonded to the blade holder 84. As long as the wiper blade 72 is fixed to the blade holder 84, a fixing method is not limited. For example, a tap may be formed in the blade holder, and the support member 84 may be fixed to the blade holder 84 by screws. Alternatively, the support member 86 may be made of thermoplastic material, and the end part may then be fixed by welding. Further, it is allowed to form a part larger than the diameter of the through hole 90 by deforming the end part of the support member 86 by heating, and fix the support member 86 to the blade holder 84 in a manner that the support member does not come out from the blade holder.

Next, a method of assembling the blade unit 80 and wiper base 96 will be explained with reference to FIGS. 7A to 7D.

The support member 102 used as a support unit is inserted into the blade holder 84 through the through hole 98 made in the blade holder and a through hole 100 made in the wiper base 96, thereby providing the wiper unit 40. The support member 102 is secured to the wiper base 96 by means of press-fitting or bonding and is assembled to rotate about the axis of the support member 102, with respect to the blade unit 80. The support member 102 extends almost parallel to the direction in which the wiping proceeds on a nozzle plate 122.

Thus, the support member 102 functions as a support for supporting the blade holder 84 on the wiper base 96. The support member 102 may be fixed to the wiper base by screws, by a tap made in the wiper base 96 and a screw provided at the end part of the support member 102. Alternatively, the support member 102 may be made of thermoplastic material, and its end may be secured by welding. Still alternatively, the support member 102 may be deformed at an end by heating, forming a part larger than the diameter of the through hole 100. In this case, the support member 102 would not come out from the wiper base.

The wiper base 96 has a concave in the area where the blade unit 80 can pivotally move. A projection may be formed on the wall 104 of the concave, to limit the angle through which the blade unit 80 can rotate. Otherwise, the wall 104 may be inclined to limit that angle.

FIGS. 7E and 7F show the wiper unit 40 with the blade unit 80 secured to the wiper base 96. The blade unit 80 is supported, able to rotate in the concave of the wiper base 96 in the direction of the arrow.

A method of assembling the wiper unit 40 and holder 4 will be explained with reference to FIG. 7G.

As described above, the wiper unit 40 is supported to the holder 44 by the spring 52. The spring 52 is held in position by the projections 62 and 64 that are formed in the wiper unit 40 and holder 44, respectively. The wiper unit 40 is biased by the spring 52 toward the cover 68 (in the Z-direction in FIG. 7G). At this time, the guide part 108 projecting from the wiper unit 40 abuts on part the reverse side 70 of the cover 68. This restricts the distance the wiper unit 40 can slide in the Z-direction.

The cover 68 has a through hole 112. In this through hole 112, a projection 114 formed integral with the holder 44 is inserted. The holder 44 is thereby supported and fixed in position. The cover 68 and holder 44 are secured by bonding. Instead, they may be fixed in position in any other manner, for example by forming taps in the holder 44 and using screws, or by making the holder 44 of thermoplastic material and fixing the end of the projection 114 by heat welding. Alternatively, the holder 44 may be deformed at an end by heating, forming a part larger than the diameter of the through hole 112. In this case, the cover 68 would not come out from the holder 44.

In this embodiment, a coil spring is used for the spring 52. Nonetheless, an elastic member such as a leaf spring may support the wiper unit 40, so long as the wiper unit 40 can has a stroke in the Z-direction.

FIG. 7H shows the maintenance block 50 in the state that the wiper unit 40 is secured to the holder 44. The wiper unit 40 is supported, able to rotate about the support member 102 and to slide in the Z-direction. The suction unit 42 (not shown in FIGS. 7A to 7H) is supported to the holder 44 by a spring, able to slide in the Z-direction as the wiper 40.

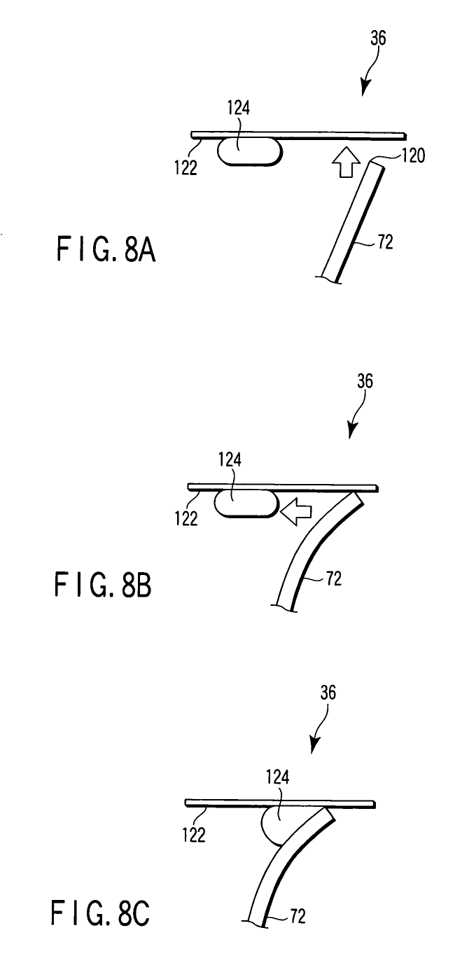

As shown in FIGS. 7B and 7F, the wiper blade 72 is fixed at a position, inclined at an arbitrary angle (angle α in FIG. 7F) to the blade holder 84, in order to make a blade end part 120 easily move along the nozzle plate surface 122 when the blade end part 120 abuts on the nozzle plate surface 122 of the ink-jet head 36 as shown in FIGS. 8A to 8C. In FIGS. 8A to 8C, the reference numeral 124 denotes an ink drop adhered to the nozzle plate surface 122.

FIG. 8A shows the blade end part 120 before touching the nozzle plate surface 122. FIG. 8B shows the blade end part after touching the nozzle plate surface. FIG. 8C shows the wiper blade 72 wiping the nozzle plate surface 122.

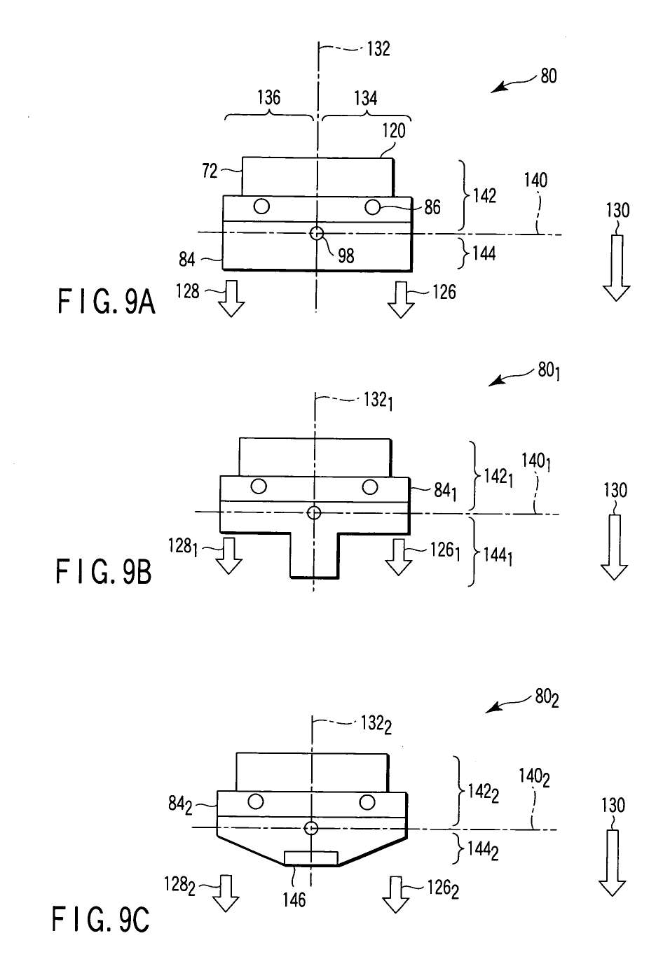

FIG. 9A shows a weight balance of the blade unit 80 comprising the wiper blade 72, blade holder 84, and support member 86. The through hole 98 has substantially equal moments R126 and L128 around the through hole 98. Thus, the weight balance is so adjusted that the weight W1 of the right side R-part 134 and the weight W2 of the left side L-part 136, divided by a centerline 132 parallel to a direction of gravity 130, becomes substantially the same.

Further, the blade end part 120 is directed to the nozzle plate surface of the ink-jet head 36 (in the reverse direction to the gravity direction 130 in FIG. 9A), whereby the state that no load is applied to the blade end part 120 of the wiper blade 72. That is, the weight W3 of the upper side U-part 142 and the weight W4 of the lower side D-part 144, which are divided by a vertical line 140 passing the center of the through hole 98 and extending vertical to the gravity direction, have the relationship of W3<W4.

As shown in FIG. 9B, moments R126₂ and L128₂ can be reduced. In addition, the D-part 144₁ of the blade holder 84₁ may be formed, so that the lower part of the blade holder 84₁ near the centerline 132₁ becomes convex (projection in the gravity direction 130 in FIG. 9B). Thus, the relation W3<W4 is established.

As shown in FIG. 9C, a weight 146 may be fixed to the underside of the blade holder 84₂ near the centerline 132₂, so that the moments R126₂ and L128₂ are decreased, and the relation W3<W4 is established. The weight 146 is made of material with a heavier specific gravity than the blade holder 84₂.

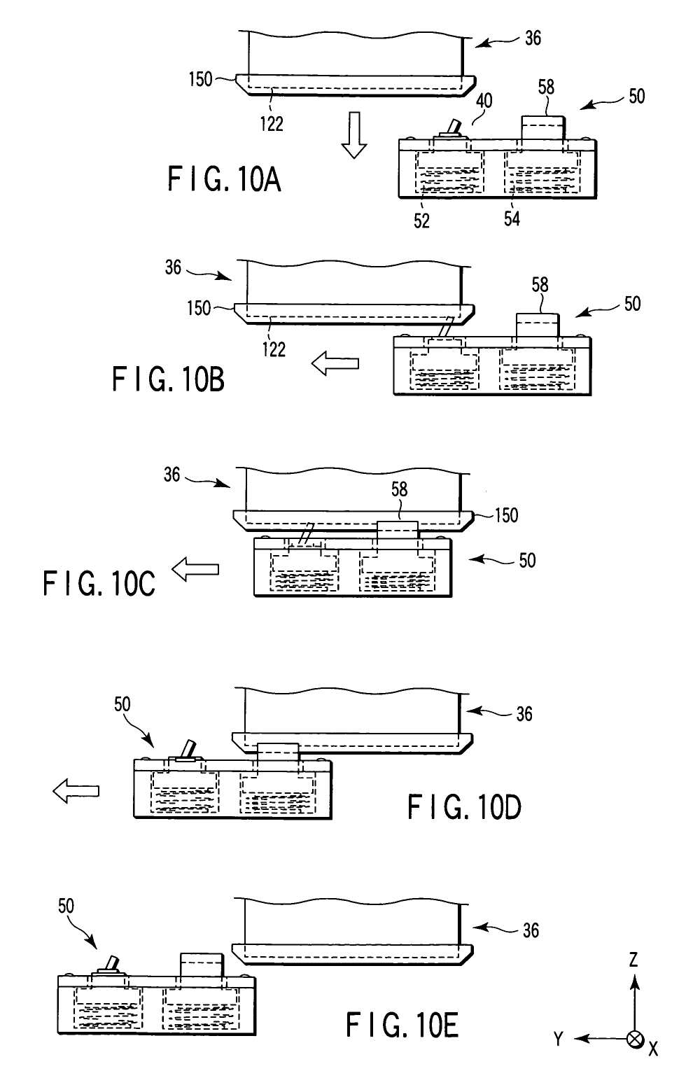

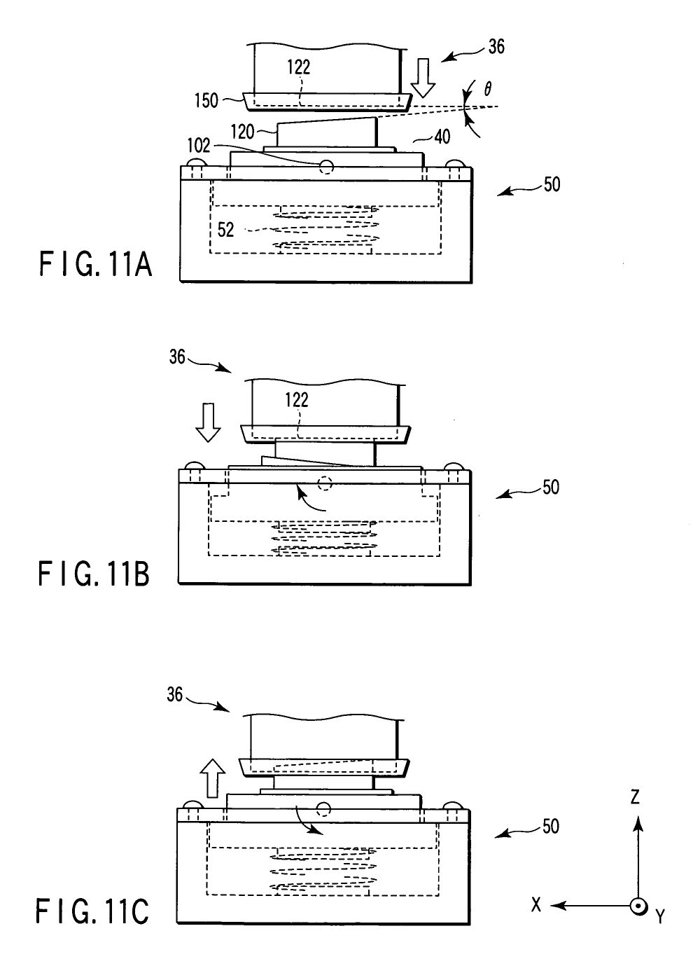

How the maintenance block 50 operates in the maintenance operation will be explained with reference to FIGS. 4A to 4G, 5A and 5B, and with reference to FIGS. 10A to 10E and 11A to 11C.

Like FIG. 3, FIGS. 10A to 10E show the positions of the ink-jet head 36 and maintenance block 50 viewed from the upstream side of a conveying direction (in the direction of arrow A in FIG. 2). FIGS. 11A to 11C are views showing views the positions of the ink-jet head 36 and maintenance block 50 viewed from the direction of arrow D in FIG. 3.

FIGS. 10A and 11A show the states that the head unit 14 and maintenance unit 18 shown in FIG. 4C are slid to the positions opposed to each other. In these drawings, the wiper blade 72 of the wiper unit 40 has yet to abut on the nozzle plate 122 of the ink-jet head 36.

Due to variations in the dimensional precision and assembly precision of the parts composing the head unit 14 and maintenance unit 18, the relative positions of the nozzle plate 122 and wiper blade 72 are not necessarily the same. For example, as shown in FIG. 11A, they may be tilted as shown in FIG. 11A (at the angle θ in FIG. 11A).

As shown in FIG. 4D, the head unit 14 is then moved downward. The wiper blade 72 of the wiper unit 40 is rotated around the support member 102, along the surface of the nozzle plate 122 of the ink-jet head 36, as shown in FIGS. 10B and 11B. That is, the wiper blade 72 rotates in the direction almost at right angles to the direction in which the nozzle plate 122 is wiped. As the wiper blade 72 so rotates, the end of the wiper blade 72 inclined to the nozzle plate 122 is pressed almost uniformly to the surface of the nozzle plate 122.

As the head unit 14 further moves downward, the contacting pressure between the wiper blade 72 and nozzle plate 122 increases. As a result, the wiper blade 72 and the nozzle plate 122 are held at a position where the pressure is balanced with the force of the spring 52 supporting the wiper unit 40, providing a desired contacting pressure. In this state, the wiper unit 40 wipes the nozzle plate 122 of the ink-jet head 36, cleaning the nozzle plate 122.

Then, as shown in FIG. 10C, the guide 58 formed in the suction unit 42 part a mask plate 150 that surrounds the nozzle plate 122. The suction unit 42 draws the ink drops from the nozzle plate 122 through the suction hole 56, at a position where it does not rub the nozzle plate 122. The spring 54 keeps pressing the suction unit 42 to the surface of the mask plate 150, with a substantially constant pressure all the time the suction unit 42 moves on the mask plate 150. The guide 58 of the suction unit 42 is chamfered to be pressed smooth to the mask plate 150.

The wiper unit 40 finishes wiping the nozzle plate 122 as shown in FIG. 10D. Then, as shown in FIG. 11C, the wiper blade 72 restores the state it assumes before it buts on the nozzle plate 122.

The suction 42 finishes the scanning operation, too, as shown in FIG. 10E. The suction unit 42 restores the state it assumes before it abuts on the mask plate 150.

In this embodiment, the mask plate 150 is convex around the nozzle plate of the ink-jet head 36. As long as the wiper blade 72 can wipe on the nozzle plate 122 at the time of cleaning, the mask plate 150 may be formed concave or at the same level as the nozzle plate 122, or the mask plate may not be provided around the nozzle plate.

Further, in this embodiment, the wiper unit 40 and the suction unit 42 are constructed in one piece as a maintenance block 50, but they may be separated considering ease of maintenance.

The ink that has flowed down and drawn by the cleaning operation is collected in a waste liquid bottle through a waste liquid path (not shown), and does not stay in the wiper unit 40 and suction unit 42. As described above, the ink may flow down from the wiper unit 40 or suction unit 42, may be received by the ink-receiving unit 46, and may be collected in the waste liquid bottle through the waste liquid path (not shown).

The wiper blade 72 is made of rubber that can be elastically deformed and be bent when cleaning the nozzle plate 122. Which kind of rubber the blade 72 should be made and which shape (thickness and fulcrum length) it should have may be determined in accordance with the resistance to ink, the resistance to wear, the workability, and the contact pressure to a nozzle plate. The spring 52 biasing the wiper blade 72 may be provided on the surface of the nozzle plate 122. Various kinds of rubber are available, including nitrile rubber (NBR), fluorine rubber (FKM), natural rubber (NR), isoprene rubber (IR), styrene butadiene rubber (SBR), butadiene rubber (BR), chloroprene rubber (CR), butyl rubber (IIR), ethylene propylene rubber (EPDM), and silicon rubber (Q). NBR or FKM, both highly resistant to oil and wear, is used for the wiper blade because oil-base ink is used in this embodiment.

As described above, in the first embodiment, the wiper blade is rotatable and can reliably abut on the nozzle plate even if relative positions of the wiper blade and nozzle plate surface change due to the variations of the parts in terms of dimensions and assemble precision. Therefore, the present embodiment can provide an image recording apparatus prevents uneven wiping and performs ink-ejection over a long use.

In this embodiment, the wiper blade is fixed at a position with an arbitrary angle, but can smoothly follow the nozzle plate when the wiper blade abuts on the nozzle plate, because the support member 102 functions as a center of rotation. Further, the wiper blade can reliably abut on the nozzle plate surface. Therefore, this embodiment can provided an image recording apparatus that prevents uneven wiping, ejecting ink in a desired manner over a long use.

In this embodiment, the wiper unit and the suction unit form a single unit, but can follow, independently of each other, the inclination and fluctuations caused by the variations of the parts in dimensions and assemble precision. Therefore, the present embodiment can provide an image recording apparatus that can prevent uneven wiping and can eject ink well over a long use. In this embodiment, the section for rotating the blade is simple in configuration, not requiring a high assemble precision or high dimensional precision of the components. This helps to lower the manufacturing cost of the image recording apparatus.

Further, in this embodiment, the wiper blade 72 is positioned, inclined at an arbitrary angle (angle α in FIG. 7) to the blade holder 84. Nonetheless, the wiper blade 72 need not be so inclined if the wiper blade 45 can rotate while contacting the nozzle plate surface 122 of the ink-jet head 36 at a contact pressure, thereby cleaning the nozzle plate surface 122.

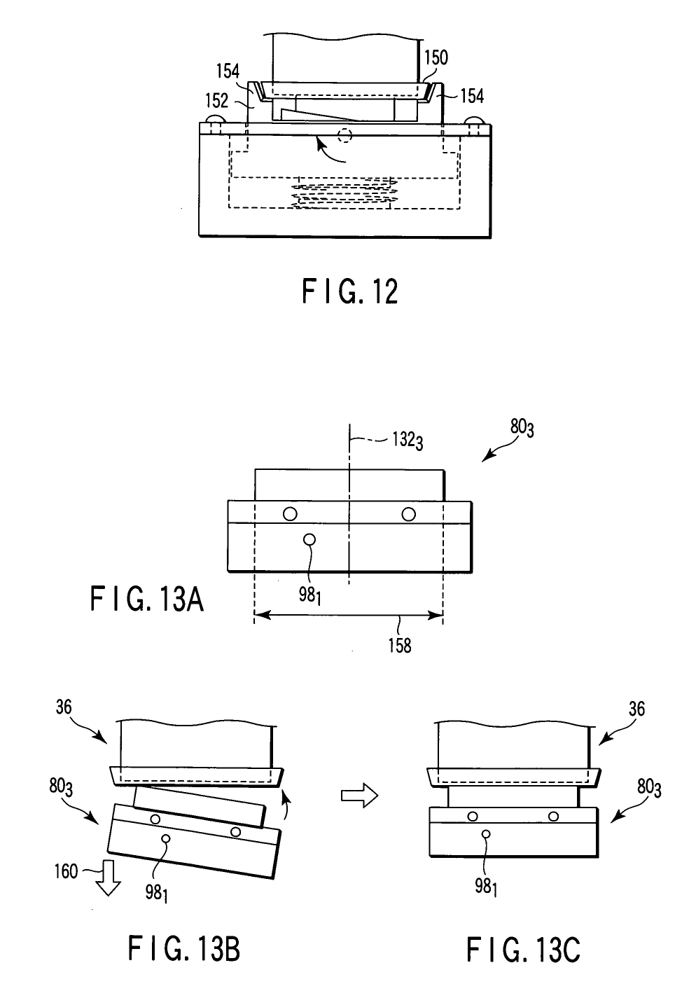

In this embodiment, the wiper unit 40 has no guide to be pressed to the mask plate 150, unlike the suction unit 42. If the wiper unit 40 needs to be positioned in the Z-direction on the mask plate 150, however, guides 154 may be provided on both sides of a wiper base 152 as shown in FIG. 12. That is, the wiper unit 40 may be positioned so that the mask plate 150 may touch the guide 154. In this configuration, too, the wiper blade can reliably abut on the nozzle plate surface when the blade unit is rotated.

In this embodiment, the weight balance of the blade unit 80 is adjusted so that the moments around the through hole 98 may become substantially equal. Nonetheless, as shown in FIG. 13A, the through hole 98₁ may be formed at a position within a range 158 inside both ends of the blade, out of the centerline 132₃ where the weight balance of the blade unit 80₃ becomes substantially equal. In this case, the blade unit 80₃ maintains an angle to the nozzle surface in the initial state, but a moment 160 acts, raising the other end part when one end part of the wiper blade abuts on the nozzle plate surface as shown in FIGS. 13B and 13C. The wiper blade therefore reliably abuts on the nozzle plate.

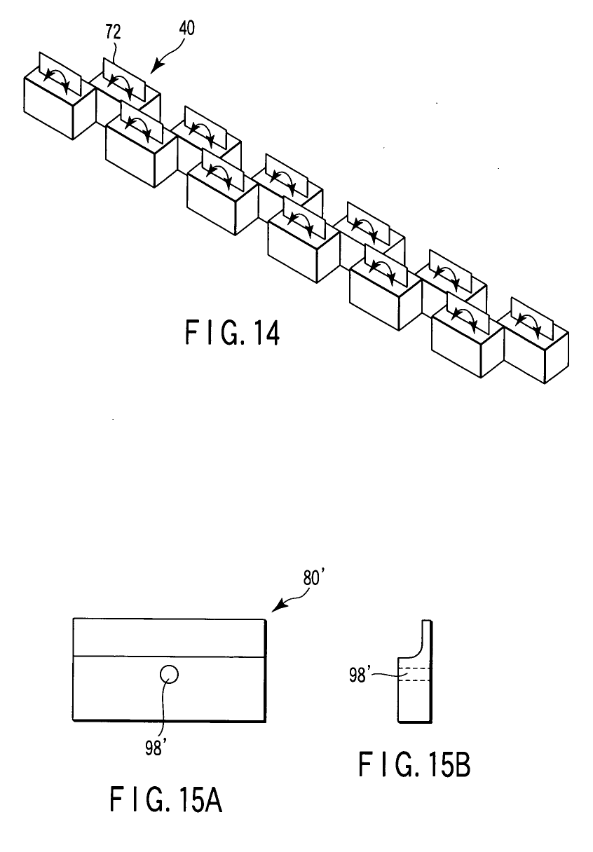

Further, as shown in FIG. 14, the wiper unit 40 is arranged, and each wiper blade 72 is rotatable to follow the nozzle plate surface even if wiping a wide range of the nozzle plate surface. Therefore, an image recording apparatus can be provided, which can prevent uneven wiping and can maintain long-term ink-ejecting performance.

In the first embodiment described above, the blade unit 80 comprises a wiper blade 72, a blade holder 84, and a support member 86. The configuration is not limited to this. For example, a blade unit 80′ may be composed of one wiper blade only as shown in FIGS. 15A and 15B. In this case, too, a wiper unit is composed of a support member 102 inserted in the through hole 98′ and through hole 100, both made in the wiper base 96. Even if the blade unit is configured as above, the same effect can be obtained.

(Modification 1)

Next, a first modification of the first embodiment will be explained.

The first modification is an example of modifying the wiper unit 40 in the first embodiment. In the wiper unit of the first modification, the blade units are arranged in a wiper base. Each blade unit is configured to rotate independently of any other when it abuts on the nozzle plate surface.

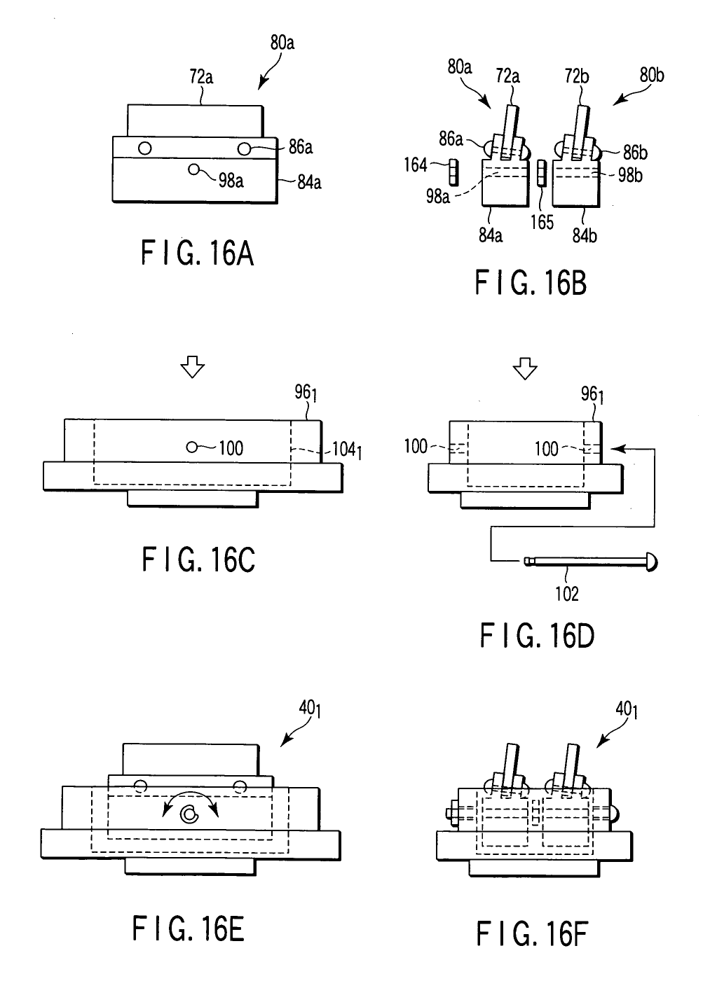

FIGS. 16A to 16F are assembly drawings showing a first modification of the wiper unit 40 used in the first embodiment of the invention. FIGS. 16A, 16C and 16E are front views (seen in the direction of arrow C in FIG. 6A). FIGS. 16B, 16D and 16F are side views (seen in the direction of arrow B in FIG. 6A).

Two wiper blades 72a and 72b are supported by blade holders 84a and 84b in the same manner as in the first embodiment.

A method of supporting the blade units 80a and 80b will be explained with reference to FIGS. 16A to 16D. Note that the blade units 80a comprise a wiper blade 72a, a blade holder 84a, and a support member 86a and that the blade unit 80b comprises a wiper blade 72b, a blade holder 84b, and a support member 86b.

The support member 102 is inserted into the through holes 98a and 98b made in the blade holders 84a and 84b, respectively, and the through hole 100 made in the wiper base 96₁. Therefore, the two blade units 80a and 80b are rotatably supported by the wiper base 98₁. The support member 102 has a flange having a larger diameter larger than the through hole, at an end, and a groove for holding a stopper ring 164, at the other end.

The axle of the support member 102 supporting the two blade units 80a and 80b has a smaller diameter smaller than the through holes 98a and 98b. The blade units 80a and 80b can therefore rotate about the axis of the support member, independently of each other. Between the two sets of blade unit 80a and 80b, a washer 166 is mounted on the axle of the support member 102, preventing one unit from being directly influenced by the friction of the other unit. An oilless bushing may be pressed into the through holes 98a and 98b of the blade units 80a and 80b to prevent friction with the axis.

As long as the two sets of blade unit 80a and 80b can rotate about the support member 102, the support member 102 may be fixed to the wiper base 96₁ by press-fitting or bonding the end part. Further, a tap may be formed in the wiper base 96₁, and a tap may be at the end part of the support member 102, in order to fix the support member in position. The support member 102 may be made of thermoplastic material, and the end part may be fixed by heat welding. Further, a part larger than the diameter of the through hole 100 may be formed by heating and deforming the end part of the support member, and the support member 102 may be fixed to the wiper base 96₁ in a manner that the support member does not come out from the wiper base.

FIGS. 16E and 16F show the wiper unit 40₁ in the state that two sets of blade units 80a and 80b are secured to the wiper base 96₁. Two blade units 80a and 80b are supported, able to rotate in a concave part, independently of each other in the direction of arrow.

In the first modification of the embodiment, two blade units are used. Instead, three or more blade units may be used.

The first modification can achieve the same advantages as the first embodiment. Further, a plurality of wiper blades can wipe the nozzle plate surface as the maintenance unit slides only once. Therefore, even ink having an increased viscosity can be removed within a short time, enhancing the efficiency of clearing.

Further, in the first modification, a plurality of wiper blades can rotate independently of one another. The wiper blades can therefore work well even if the inclination of the wiper blade to the nozzle plate surface deviates from a desired value due to the variations of the components in terms of dimensions and assemble precision. Therefore, the first modification can provide an image recording apparatus that can prevent uneven wiping and can maintain goo ink-ejecting ability over a long use.

(Modification 2)

A second modification of the first embodiment will be described.

The second modification has a wiper unit that is a modification of the wiper unit 40 used in the first embodiment. The wiper unit is configured to be easily removed from the wiper base 96.

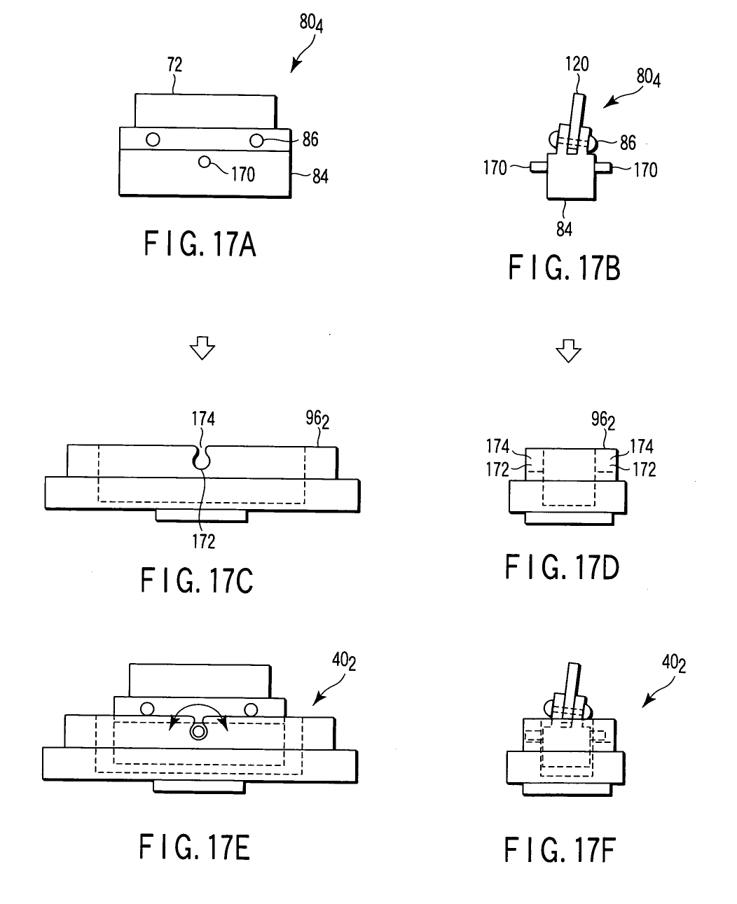

FIGS. 17A to 17F are diagrams explaining how the second modification of the wiper unit 40 used the first embodiment is assembled. FIGS. 17A, 17C and 17E are front views (as seen in the direction of arrow C in FIG. 6A). FIGS. 17B, 17D and 17F are side views (as seen in the direction of arrow B in FIG. 6A).

The wiper blade 72 is supported by the blade holder 84 in the same manner as in the first embodiment.

A method of supporting a blade unit 80₄ comprising a wiper blade 72, a blade holder 84, and a support member 86 will be explained with reference to FIGS. 17A to 17D.

A support member 170 formed integral with the blade holder 84 and provided on both sides of the blade holder 84 is inserted into a through hole 172 made in a wiper base 96₂. The blade unit 80₄ is thereby supported on the wiper base 96₂. The support member 170 functions as a support for supporting the blade holder 84 on the wiper base 96₂. The support member 170 has a smaller diameter smaller than the through hole 172. The blade unit 80₂ can therefore rotate. The through hole 172 has an aperture 174 smaller than the diameter of the support member 170. Once the support member 170 has been fitted into the aperture 174, the blade unit 80₄ is supported on the wiper base 96₂.

In the second modification, the support member 170 is formed in one piece with the blade holder 84. Nonetheless, a pin made of resin or metal may be driven into or bonded to the blade holder 84.

FIGS. 17E and 17F show a wiper unit 40₂ with blade unit 80₄ secured to the wiper base 96₂. The blade unit 80₄ is supported, able to rotate in a concave the wiper base 96₂, in the direction of the arrow.

The second modification of the first embodiment can achieve the same effects as the first embodiment can be obtained. In addition, the blade unit 80₄ can be fitted in the wiper base 96₂, and can be easily removed from the wiper base able 96₂. The wiper blade 72 can be easily replaced by a new one if it has deteriorated and needs to be replaced. Therefore, the second modification can provide an image recording apparatus that can be readily maintained.

(Modification 3)

A third modification of the first embodiment will be explained.

The third modification has a wiper unit that is a modification of the wiper unit 40 used in the first embodiment. The wiper unit 40 of the third modification can be easily removable from the wiper base 96.

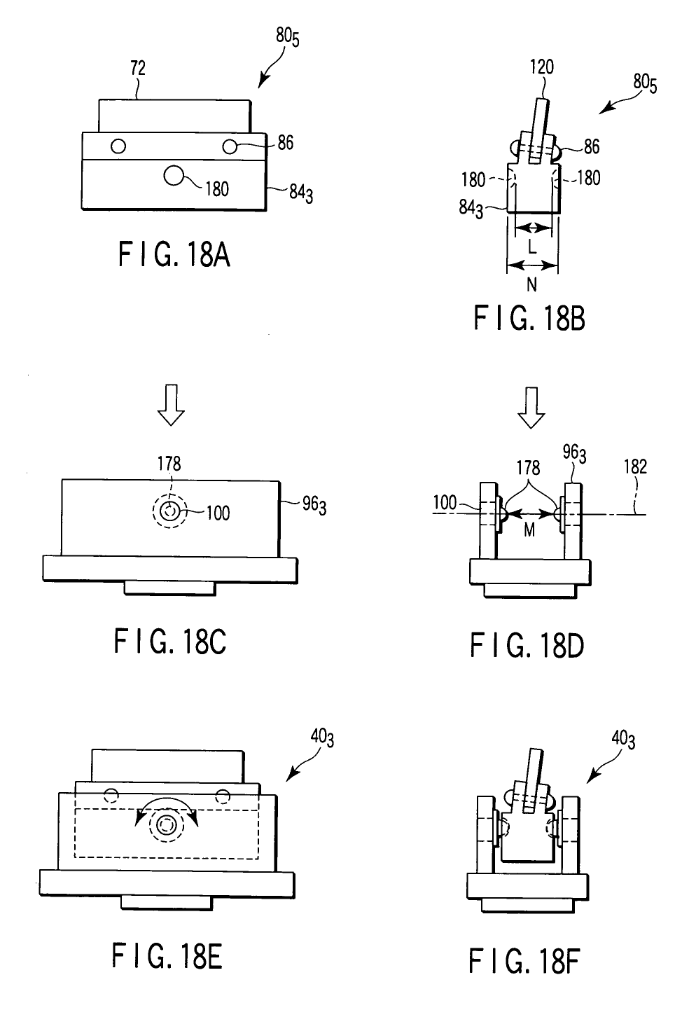

FIGS. 18A to 18F are diagrams explaining how the third modification of the wiper unit 40 used in the first embodiment. FIGS. 18A, 18C and 18E are front views (as seen in the direction of arrow C in FIG. 6A). FIGS. 18B, 18D and 18F are side views (as seen in the direction of arrow B in FIG. 6A).

The wiper blade 72 is supported by blade holder 84₃ in the same manner as in the first embodiment.

A method of supporting a blade unit 80₅ comprising a wiper blade 72, a blade holder 84₃, and a support member 86 will be explained with reference to FIGS. 18A to 18D.

A pair of ball rollers 178, i.e., spherical projections, are fitted into the through hole 100 made in a wiper base 96₃. The spherical parts of the ball rollers 178 are embedded into spherical depressions 180 made in both sides of a blade holder 84₃. A blade unit 805 is thereby supported on the wiper base 96₃ through the ball rollers 178. The ball rollers 178 and depressions 180 function as supporters, supporting the blade holder 84₃ on the wiper base 96₃. The depression 180 formed in the blade holder 84₃ has an arc diameter larger than the diameter of the spherical part of the ball roller 178. The distance M between the spherical parts of the ball rollers 178, the width N of the blade holder 84₃ and the distance L between the depressions formed in the blade holder 84₃ have relation of N>M>L. Therefore, the blade unit 80₅ is supported, able to rotate about an axis 182.

Further, in the third modification, the ball rollers 178 support the blade unit 80₅. Instead, the blade unit 80₅ may be rotatably supported by the depression 180 made in the blade holder 84₃ by providing a spherical surface, such as a plunger. The ball rollers 178 are fastened to the wiper base by press-fitting or bonding, or by using screws. A polyacetal ball or stainless ball is mounted on the spherical surface.

FIG. 18E and 18F show a wiper unit 40₃ with the blade unit 80₅ secured to the wiper base 96₃. The blade unit 80₅ is supported and can rotate in a concave made in the wiper base 96₃ in the direction of arrow.

The third modification can achieve the same effect as the first embodiment can be obtained. In addition, the blade unit 80₅ is fitted in the wiper base 96₃, and can yet be easily removed. The wiper blade 72 can therefore be easily replaced with a new one if it has deteriorated and should be replaced. Therefore, the third modification can provide an image recording apparatus that can be well maintained.

### Embodiment 2

A second embodiment of the invention will be described.

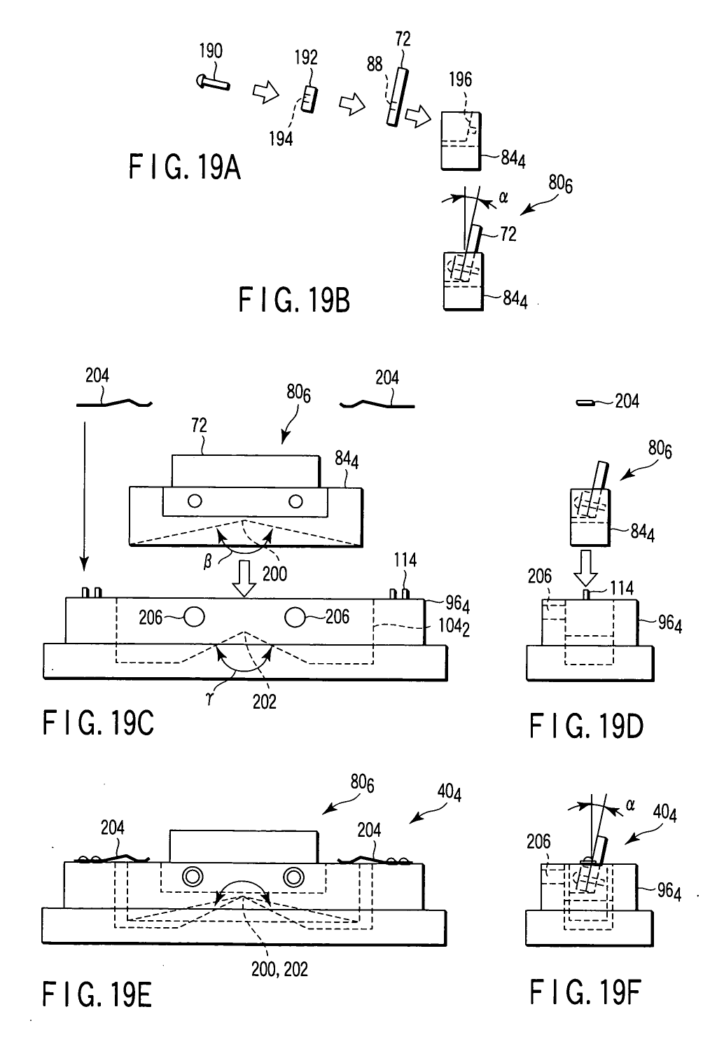

FIGS. 19A to 19F are drawings showing how a blade unit, a wiper unit, and a maintenance block are combined together to assemble an image recording apparatus according to the second embodiment of the invention. FIGS. 19A, 19B and 19D are side views (as seen in the direction of arrow B in FIG. 6A). FIGS. 19C, 19E and 19F are front views (as seen in the direction of arrow C in FIG. 6A).

The image recording apparatus according to the second embodiment is identical to the first embodiment shown in FIGS. 1 to 18, in basic configuration and basic operation. Therefore, the components identical to those of the first embodiment are designated by the same reference numbers and will not be described. Likewise, the operations identical to those of the first embodiment will not be described. Only the different components and different operations will be described below.

First, a method of supporting the wiper blade 72 in the second embodiment will be explained with reference to FIGS. 19A and 19B.

A support member 190 is inserted into the through hole 194 made in a support member 192 and into the through hole 88 made in the wiper blade 72. One end part of the support member 190 is supported in a hole made in the blade holder 84₄. The wiper blade 72 is therefore pressed onto a slope formed in the blade holder 84₄. The wiper blade 72 abuts on the slope 196 is supported by the blade 82₄ with an arbitrary angle (angle α in FIG. 19B).

For example, the support member 190 is a screw, and the hole formed in the blade holder 84₄ is a tap. A worn wiper blade can be replaced by a new one, as a single unit (minimum unit).

A method of supporting the blade unit 89₆ comprising the wiper blade 72, blade holder 84₄, support member 190 and a support member 192, with reference to FIGS. 19C and 19D.

The blade holder 84₄ is provided with a triangular depression 200. The wiper base 96₄ is provided with a triangular projection 202 corresponding to the depression 200. By contacting the bottom of the depression 200 and the ridgeline of the projection 202, the blade unit 80₆ is supported on the wiper base 96₄. The depression 200 and projection 202 function as a support for supporting the blade holder 84₄ on the wiper base 96₄. At this time, the center angle β of the triangular depression 200 formed in the blade holder 84₄ and the center angle γ of the triangular projection 202 formed in the wiper base 96₄ are set to β>γ. The blade unit 80₆ therefore rotates about the bottom of the projection 200 and the ridge of the depression 202.

A projection 114 is formed on both sides of the wiper base 96₄. A spring 204 is fixed and positioned to and at the projection 114. The blade unit 80₆ is thereby supported substantially horizontal.

So long as the spring 204 is fixed to the wiper base 96₄, the wiper base 96₄ may be made of thermoplastic material and welded by heating. A tap may be provided in the wiper base 96₄. In this case, the spring 204 may be secured with a screw. The wiper base 96₄ may have a depression, in which the blade unit 80₆ can rotate.

A projection may be provided on the wall 104₂ of the concave to restrict the range of rotating the blade unit 80₆, or the wall 104₂ may be inclined to restrict the rotating range. A through hole 206, through which the support member 190 can be accessed, is made in one side of the wiper base 96₄. Therefore, the support member 190 can be removed through the through hole 206, in order to replace the wiper blade 72 with a new one.

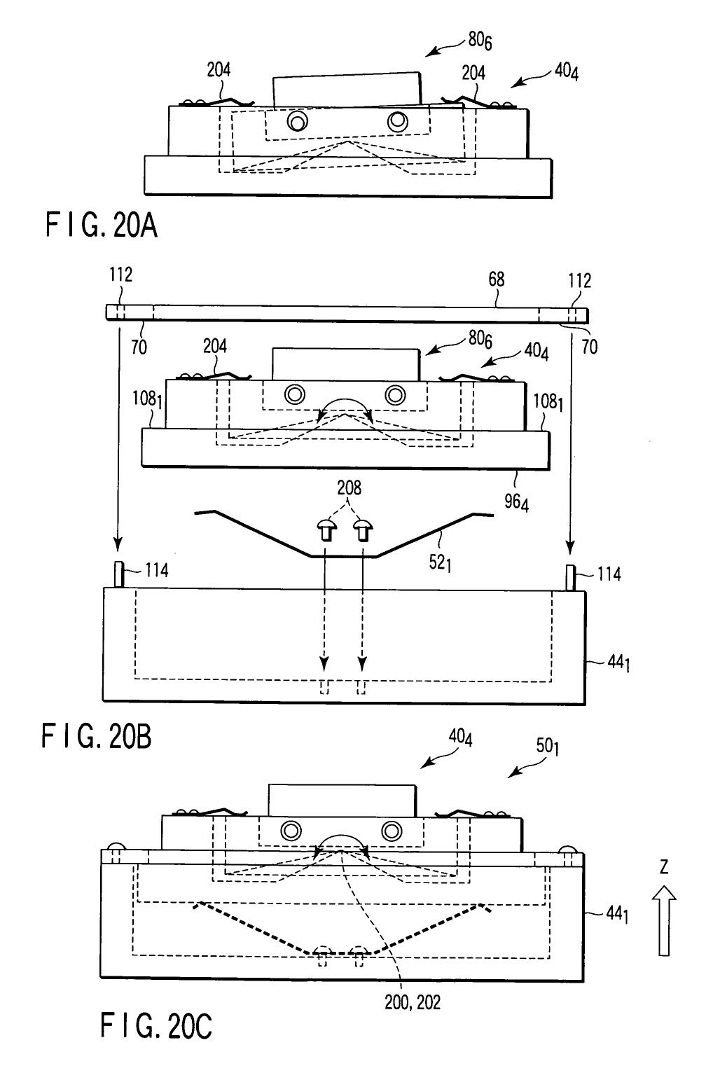

As shown in FIG. 20A, the spring 204 holds the blade unit 80₆ with a force that does not interrupt the rotating operation. When the blade unit is inclined by rotation, only the spring 204 on one side (right side in FIG. 20A) follows the inclination, and the other spring 204 (left side in FIG. 20A) is set free.

FIGS. 19E and 19F show the wiper unit 40₄ in the state that the blade unit 80₆ is secured to the wiper base 96₄. The blade unit 80₆ can rotate in the concave of the wiper base 96₄ about the bottom of the depression 200 and the ridge of the projection 202, in the direction of arrow.

In this embodiment, the wiper base 96₄ is provided with the through hole 206 to make the support unit 190 removable. Nonetheless, so long as the support member is removable, a concave accessible to the support member 190 may be made in one side of the wiper base 96₄.

A method of supporting the wiper unit 40₄ comprising the blade unit 80₆, spring 204 and wiper base 96₄, with reference to FIG. 20B will be explained with reference to FIG. 20B.

The wiper unit 40₄ is supported by a holder 44₁ through a spring 52₁. The spring 52₁ is positioned and fixed to the holder 44₁ by a support member 208. The spring 52₁ biases the wiper unit 40₄ toward the cover 68. At this point, the upper surface of the guide unit 108₁ formed as a projection on both sides of the wiper unit 40₄ abuts on the back 70 of the cover 68. The guide unit 108₁ therefore restricts the distance the wiper unit 40₄ can slide in the Z direction.

The cover 68 has a through hole 112. The projection 114 formed in the holder 44₁ is inserted into the through hole 112, supporting and positioning the cover. The cover 68 is fixed to the holder 44₁ by bonding. As long as the cover 66 and holder 44₁ can be positioned and fixed, the cover can be fixed with a screw by providing a tap in the holder 44₁. The holder 44₁ may be made of thermoplastic material, and the end part of the projection 114 may be fixed by welding. A part larger than the diameter of the through hole 112 of the cover 68 can be formed by deforming the end part of the projection 114 by heating, and the cover 68 can therefore be fixed, not to coming off from the holder 44₁.

FIG. 20C shows a maintenance block 50₁ with the wiper unit 40₄ secured to the holder 44₁. The wiper unit 40₄ is supported, able to rotate about the bottom of the depression 200 and the ridge of the projection 202, and can slide in the Z-direction.

The suction unit 42 not shown here is also supported on the holder 44₁ by a spring and can slide in the Z-direction as is the wiper unit 40₄.

As shown in FIGS. 19B and 19F, the wiper blade 72 is fixed to the slope 196 of the blade holder 84₄, and held inclined at an angle (angle α in FIGS. 19B and 19F). Therefore, the blade end part 120 can easily rotate, following the nozzle plate surface 122 when the blade end part 120 contacts the nozzle plate surface 122 of the ink-jet head 36 as shown in FIGS. 8A to 8C.

The ink that has flowed down and drawn by the cleaning operation is collected in a waste liquid bottle through a waste liquid path (not shown). Hence, the ink would not remain in the wiper unit 40₄. The ink may indeed flow down from the wiper unit 40₄. Nevertheless, the ink is collected in the ink-receiving unit 46, and supplied into the waste liquid bottle through a waste liquid path (not shown) as has been described above.

In the second embodiment, the wiper blade can rotate and can therefore reliably abut on the nozzle plate even if the wiper blade and nozzle plate surface change in position due to variations of the components in dimensions and assemble precision. Therefore, the second embodiment can therefore provide an image recording apparatus that makes no uneven wiping and can eject ink well over a long use.

Further, In the second embodiment, the wiper blade is fixed at a position, incline at an arbitrary angle and can therefore easily slide on the nozzle plate, at a contact pressure, and the wiper blade can reliably abut on the nozzle plate surface. Therefore, the second embodiment can provide an image recording apparatus that can prevent uneven wiping and can eject ink well over a long use.

Furthermore, in the second embodiment, the configuration to rotate the blade is simple and its components need not have high dimensional precision or assemble precision. The second embodiment can therefore provide a n image recording apparatus at low manufacturing cost.

Still further, in the second embodiment, the wiper blade can be detached (because it is fixed with screws). The wiper blade, if worn by wiping, can be replaced by a new one. Therefore, the second embodiment can provide an image recording apparatus that has a few components and in which the wiper blade 72, if degraded, can be replaced by a new one.

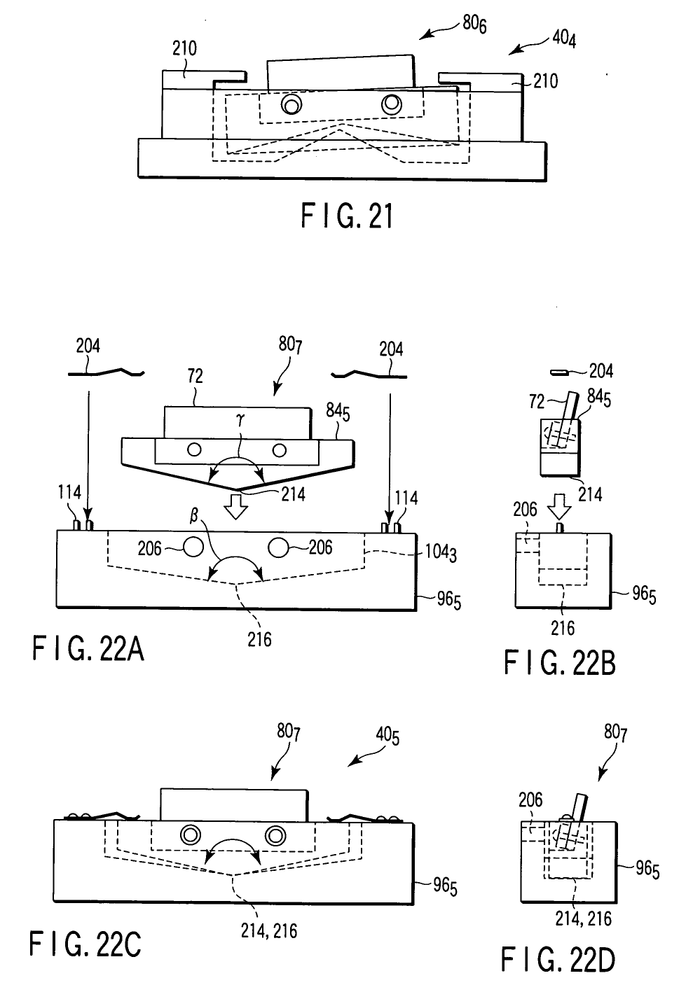

In the second embodiment, the blade unit 80₆ is held by the spring 204 from both sides. The holding method is not limited to this, as long as the blade unit 80₆ is rotatable about the bottom of the depression 200 and the ridgeline of the projection 202, and does not come out from the wiper base 96₄. Therefore, it is allowed to form a stopper 210 on the wiper base 96₄, instead of the spring 204, as shown in FIG. 21.

Further, as shown in FIG. 14, a plurality of wiper units 40 are staggered so that each wiper blade 72 can rotate on the nozzle plate surface, even while wiping the broad nozzle plate surface. The second embodiment can therefore provide an image recording apparatus that can prevent uneven wiping can eject ink well over a long use.

(Modification)

A modification of the second embodiment will be described.

This modification has a wiper unit that is a modification of the wiper unit 40 of the second embodiment. The triangular part in the blade holder 84₄ is a projection, and the triangular part in the wiper base 96₄ is a depression.

FIGS. 22A to 22D are diagrams showing how the modified wiper unit 40 is assembled. FIGS. 22A and 22C are front views (as seen in the direction of arrow C in FIG. 6A). FIGS. 22B and 22D are side views (as seen in the direction of arrow B in FIG. 6A).

The wiper blade 72 is supported by the blade holder 84₅ in the same manner as in the second embodiment.

A method of supporting a blade unit 80₇ will be explained with reference to FIGS. 22A and 22B.

A triangular projection 214 pointed downwards is provided on the blade holder 84₅. A triangular depression 216 extending downwards is made in the wiper base 96₅. When the ridge of the projection 214 abuts on the bottom of the depression 216, the blade unit 80₇ is supported in the wiper base 96₅. The depression 216 and projection 214 function as a supports for supporting the blade holder 84₅ in the wiper base 96₅. At this time, the center angle γ of the triangular projection formed in the blade holder 84₅ and the center angle β of the triangular depression formed in the wiper base 96₅ have relation of β>γ. That is, the blade unit 80₇ can rotate about the ridge of the projection 214 and the bottom of the depression 216.

A projection 114 is formed on both sides of the wiper base 96₅. A spring 204 is positioned at and fixed to the projection 114. The blade unit 80₇ is thereby supported substantially horizontal. The wiper base 96₅ has a depression in which the blade unit 80₇ can rotate.

A projection may be provided on the inside wall 104₃ of the depression to restrict the angle through which the blade unit 80₇ can rotate. The inside wall 104₃ of the depression may be inclined to restrict the angle through which the blade unit 80₇ can rotate.

FIGS. 22C and 22D show the wiper unit 40₅ with the blade unit 80₇ secured to the wiper base 96₅. As shown in these figures, the blade unit 80₇ is supported rotatable in the concave made in the wiper base 96₅, about the bottom of the depression 216 and the ridge of the projection 214 in the direction of arrow.

The modification of the second embodiment can provide an image recording apparatus that can achieve the same advantages as the second embodiment.

### Embodiment 3

A third embodiment of the invention will be described.

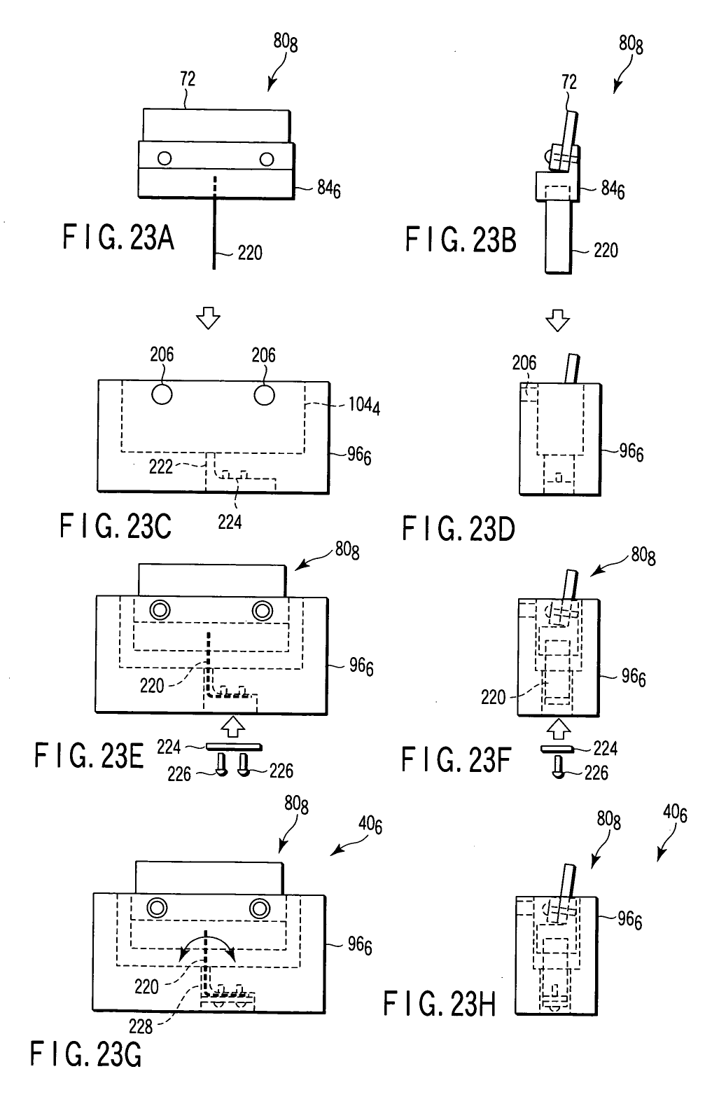

FIGS. 23A to 23H are diagrams explaining how a blade unit and wiper unit of an image recording apparatus according to the third embodiment are assembled. FIGS. 23A, 23C, 23E and 23G are front views (as seen in the direction of arrow C in FIG. 6A). FIGS. 23B, 23D, 23F and 23H are side views (as seen in the direction of arrow B in FIG. 6A).

The third embodiment is identical in basic configuration and basic operation to the image recording apparatus according to the first embodiment shown in FIGS. 1 to 18. Therefore, the components identical to those of the first embodiment are designated by the same reference numbers and will not be described. Likewise, the operations identical to those of the first embodiment will not be described. Only the different components and different operations will be described below. Further, how the wiper blade is secured to the blade holder will not be explained since it the blade is secured in the same way as in the second embodiment.

A method of supporting a blade unit in the third embodiment of the invention will be explained with reference to FIGS. 23A to 23F.

One end part of a leaf spring 220 is fixed, by press-fitting or bonding, in a groove made in the blade holder 84₆. And extending in the Y-direction. The other end of the leaf spring 220 is inserted into a through hole 222 made in a wiper base 96₆, is bent by about 90 degrees, and is pressed to a fixing plate 224. A support member 226 is fixed to the wiper base 96₆, or inserted in the through hole made in the fixing plate 224 and in the through hole made at the other end part of the leaf spring 220. Therefore, a blade unit 80₈ is supported on the wiper base 96₆ through the leaf spring 220. The wiper base 96₆ has a depression in the area where the blade unit 80₈ is movable at various angles.

A projection may be formed on the concaved wall 104₄ to restrict the movable angle range of the blade unit 80₈. Alternatively, the wall 104₄ may be inclined to restrict the movable angle range.

FIGS. 23G and 23H show the wiper unit 406 in the state that the blade unit 80₈ is secured to the wiper base 96₆. The blade unit 80₈ is supported, able to rotate at various angles in the direction of arrow in a concave part of the wipe base 96₆, about a support point 228 where the leaf spring 220 is supported in the wiper base 96₆.

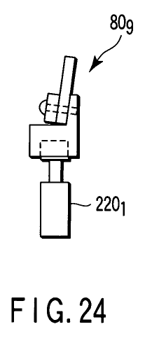

As shown in FIG. 24, a leaf spring 220₁ may have a smaller width to increase the sensitivity to the movement at various angles with respect to the contact pressure to the nozzle plate surface.

In the third embodiment, since the wiper blade can incline at various angles, the wiper blade can reliably abut on the nozzle plate even if the positions of the wiper blade and nozzle plate surface change due to variation of the components in dimensions and assemble precision. Therefore, the third embodiment can provide an image recording apparatus that can prevent uneven wiping and can eject ink well over a long use.

In the third embodiment, the wiper blade is fixed in position and inclined at an arbitrary angle, the wiper blade can easily follow the nozzle plate according to a contact pressure at which it contacts the nozzle plate, and the wiper blade can reliably abut on the nozzle plate surface. Therefore, the third embodiment can provide an image recording apparatus that can prevent uneven wiping and can eject ink well over a long use.

The invention has been described, with reference to several embodiments that are all line-type image recording apparatuses having a line head with a column of nozzles, which has a length equivalent to the width of a recording medium. Nevertheless, the invention is not limited to line-type image recording apparatus. The invention can be applied to, for example, a serial-type image recording apparatus. Various changes and modifications can be made, without departing from the spirit and scope of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image recording apparatus comprising:
a nozzle plate having a nozzle hole to eject ink;
a wiper blade for cleaning the nozzle plate;
a blade holder for holding the wiper blade; and
a wiper base which contains the blade holder, and holds the blade holder,
wherein when the wiper blade abuts on the nozzle plate, the blade holder is held in the wiper base to be inclinable in a direction substantially perpendicular to a direction in which the wiper blade cleans the nozzle plate.

2. The image recording apparatus according to claim 1, further comprising a support unit for supporting the blade holder in the wiper base,
wherein the blade holder is rotated, rotating the wiper blade about the support unit with respect to the wiper base.

3. The image recording apparatus according to claim 2, wherein the support unit has a support shaft which is inserted into a through hole formed in the blade holder, and supports the blade holder, and
both ends of the support shaft are held by the wiper base, and the blade holder is rotated about the support shaft with respect to the wiper base.

4. The image recording apparatus according to claim 2, wherein the support unit has a support shaft formed in the blade holder, and support shaft is held by the wiper base, and the blade holder is rotatable about the support shaft with respect to the wiper base.

5. The image recording apparatus according to claim 3, wherein the wiper base is provided with a through hole to hold the support shaft, a part of the through hole has an aperture with the width smaller than the diameter of the support shaft, and the support shaft is removable through the aperture.

6. The image recording apparatus according to claim 4, wherein the wiper base is provided with a through hole to hold the support shaft, a part of the through hole has an aperture with the width smaller than the diameter of the support shaft, and the support shaft is removable through the aperture.

7. The image recording apparatus according to claim 3, wherein the support shaft is arranged substantially parallel to a direction in which the cleaning of the nozzle plate proceeds.

8. The image recording apparatus according to claim 4, wherein the support shaft is arranged substantially parallel to a direction in which the cleaning of the nozzle plate proceeds.

9. The image recording apparatus according to claim 2, wherein the support unit has a depression formed spherical on both sides of the blade holder, and a projection formed spherical in the wiper base at a position corresponding to the depression of the blade holder; and the blade holder is rotated about a position where the projection and depression are fit to each other with respect to the wiper base, by fitting the projection of the wiper base into the depression of the blade holder.

10. The image recording apparatus according to claim 2, wherein the support unit has a projection formed spherical on both sides of the blade holder, and a depression formed spherical in the wiper base at a position corresponding to the projection of the blade holder; and the blade holder is rotated about a position where the projection and depression are fit to each other with respect to the wiper base, by fitting the projection of the blade holder into the depression of the wiper base.

11. The image recording apparatus according to claim 2, wherein the support unit has a triangular depression formed on that side of the blade holder which is opposite to the side to hold the wiper blade, and a triangular projection formed in the wiper base at a position corresponding to the triangular depression; and the blade holder is rotated about a position where the projection and depression are pressed to the wiper base, by placing the depression of the blade holder on the projection of the wiper base.

12. The image recording apparatus according to claim 11, wherein the center angle β of the triangular depression formed in the blade holder and the center angle γ of the triangular projection formed in the wiper base are set to β>γ.

13. The image recording apparatus according to claim 2, wherein the support unit has a triangular projection formed on the side of the blade holder opposite to the side to hold the wiper blade, and a triangular depression formed on the wiper base at a position corresponding to the triangular projection; and the blade holder is rotated about a position where the projection and depression are pressed the wiper base, by placing the projection of the blade holder on the depression of the wiper base.

14. The image recording apparatus according to claim 13, wherein the center angle γ of the triangular projection formed in the blade holder and the center angle β of the triangular depression formed in the wiper base are set to β>γ.

15. The image recording apparatus according to claim 11, wherein the ridgeline of the projection or the bottom of the depression extends substantially parallel to a direction in which the cleaning of the nozzle plate proceeds.

16. The image recording apparatus according to claim 13, wherein the ridge of the projection and the bottom of the depression extend substantially parallel to a direction in which the cleaning of the nozzle plate proceeds.

17. The image recording apparatus according to claim 1, further comprising a through hole formed in the wiper base, and a leaf spring whose one end is fixed to the blade holder and the other end is fixed to the wiper base through the through hole,
wherein the blade holder is tilted in the thickness direction of the leaf spring with respect to the wiper base so that the wipe blade follows the nozzle plate.

18. The image recording apparatus according to claim 1, wherein the blade holder has a slope with an arbitrary inclination to the plane orthogonal to the nozzle plate, and holds the wiper blade on the slope.

19. The image recording apparatus according to claim 18, wherein the slope is inclined so that an angle defined by the wiper blade and the nozzle plate being cleaned is larger than 0° and smaller than 90°.

20. An image recording apparatus comprising:
a nozzle plate having a nozzle hole to eject ink;
a wiper blade having a through hole for cleaning the nozzle plate;
a support shaft inserted in the through and supporting the wiper blade; and
a wiper base to hold the support shaft,
wherein when the wiper blade abuts on the nozzle plate, the wiper blade is rotated about the support shaft with respect to the wiper base, following the nozzle plate surface and rotating in a direction substantially at right angles to the direction in which the cleaning of the nozzle plate proceeds.
